(19) United States
(12) Patent Application Publication
(10) Pub. No.: US 2002/0126727 A1
(43) Pub. Date: Sep. 12, 2002

(54) Quick change laser design

(75) Inventors: Yefim P. Sukhman, Scottsdale, AZ (US); Christian J. Risser, Scottsdale, AZ (US); Edwin W. Gorham, Phoenix, AZ (US); Stefano J. Noto, Mesa, AZ (US); Tyler T. Best, Scottsdale, AZ (US)

Correspondence Address: LAW OFFICE OF DONALD J LISA, 6636 NORTH 48TH STREET, PARADISE VALLEY, AZ, 85253-4056, US

(73) Assignee: UNIVERSAL LASER SYSTEMS, INC., SCOTTSDALE, AZ (US)

(21) Appl. No.: 09/777,770

(22) Filed: Feb. 5, 2001

(51) Int. Cl. H01S 3/00

(52) U.S. Cl. 372/109

(57) ABSTRACT

A laser system 20 enables quickly releasing and replacing a laser source 41 mounted in a laser compartment 40 by interfacing engaging members 32,43 of the platform 40 and source 41, respectively to place the pre-aligned beam 42 in operative relation with the pre-aligned beam delivery system 31 and closing the compartment with a latchable 45 cover 44 without the use of any tools and without the need for any additional beam alignment. A deformable spacer 47 holds the source in place when the cover is closed, and a switch 48 automatically interrupts power when the cover is opened,

### CROSS-REFERENCES TO RELATED APPLICATIONS

Not Applicable

### STATEMENT REGARDING FEDERALLY SPONSORED RESEARCH AND DEVELOPMENT

Not Applicable

### BACKGROUND OF THE INVENTION

1. Fields of the Invention

The present invention relates generally to apparatuses and methods of routinely removing and installing lasers quickly, with minimal effort and without tools, and, more particularly, to such apparatuses and methods which enable quickly accessing the laser compartment of a laser material processing system and quickly interchanging the laser source mounted therein without the use of tools while simultaneously placing the laser beam of the replacement laser source coincident with the axis of the beam delivery system without the need for additional adjustment.

2. Discussion of Background and Prior Art

### Background

Traditional laser engraving and cutting systems are usually designed for a certain model laser source with a certain power output which is usually permanently mounted in the laser system. Each laser source's beam is usually individually aligned to the beam delivery system of a particular machine after the laser is installed in the system.

However, to maximize productivity, especially for customers with multiple machines, it is highly desirable to have a flexible laser processing solution to each laser application such that customers can quickly and easily interchange laser sources of different power ratings in machines of different sizes and capabilities to match resources to jobs.

### Prior Art

### a. Prior Laser System Quick Access, Laser Cartridge, Compartment Covers

In a prior mobile laser material processing system by applicants' assignee there is disclosed a readily accessible electronic equipment compartment, which includes a laser cartridge, located at the top rear of the system. The laser compartment has a quick access cover having a vertical back wall and a horizontal top wall, forming an L-shaped profile in cross section, with the cover's back and top walls fastened by screws to the laser compartment. The cover does not engage the top of the laser cartridge when the latter is installed and the cover is closed.

See also, Daly U.S. Pat. No. 4,507,789 which discloses a yag laser system having a portable laser pot unit 12 in a mobile housing 14. The laser pot unit 12 itself has a quickly unlatchable outer rectangular cover. Secured inside laser pot unit 12 is a further cover 34 with further quick release latches 36 for a housing 32 permitting quick access to the interior thereof for making periodic changes of the lamp 40 without tools. Cover 34 protects the technician's eyes in the event the lamp explodes during an exchange. See also Daniels U.S. Pat. No. 5,184,153 which discloses doors 14, 15a permitting easy access to the interior compartments of a laser printer for servicing the unit. A problem with all of the above quick access, laser cartridge compartment covers is that tools are required to remove and install the laser cartridge itself requiring the services of a skilled technician and slowing the process of interchangeably interfacing the laser source with the platform to do custom laser engraving and cutting operations. A further problem with the Daly system is that realignment adjustments are required with each laser exchange.

Accordingly, it is an object of the present invention to provide a tool-less apparatus and method for interchangeably interfacing a laser source with a laser material processing system while simultaneously placing the laser beam of the replacement laser source coincident with the axis of the beam delivery system without the need for additional adjustment.

### b. Prior Hinged, Quick Access, Compartment Covers For Electronic Equipment

Hinged, quick access, compartment covers for electronic equipment are generally known. Lotz U.S. Pat. No. 5,056,331 discloses in FIGS. 5-9 an enclosure for electronic equipment with air intake and exhaust means and a hinged 47 upper compartment partial cover 46 with a handle to open rearwardly and permit quick access for servicing electronic components therein. Bruni U.S. Pat. No. 3,997,221 discloses an electronic equipment cabinet for a laser-nephelometer with lower and upper compartments housing electronic components e upper housing section 9b of which is upwardly and rearwardly tiltable about hinge pins 20 exposing the interior for service and cleaning. See also Eizadkhah U.S. Pat. No. 6,082,845 disclosing a forwardly tiltable top section, and Zachri U.S. Pat. No. 5,801,331 disclosing a rearwardly opening hinged top cover for servicing components. These hinged, quick access, compartment covers can be opened without the use of tools, but none of them disclose or suggest quick interchange of a laser source.

Accordingly, there is not available on the market, there is still a need for, and, it is an object of the present invention to provide, an apparatus and method for not only quickly accessing the laser compartment of a laser material process system, but also quickly interchanging the laser source mounted therein without the use of tools while simultaneously placing the beam of the replacement laser source coincident with the axis of the beam delivery system without the need for additional adjustment.

### BRIEF SUMMARY OF THE INVENTION

Set forth below is a brief summary of the invention which achieves the foregoing and other objects and provides the foregoing and hereafter stated benefits and advantages in accordance with the structure, function and results of the present invention as embodied and broadly described herein. Applicants' invention includes independently both the apparatus and the methods described herein which achieve the objects and benefits of the present invention. Both formats of the invention are described below, and it is the applicants' intention to claim both formats even though from time to time below for purposes of clarity and brevity applicants may use either one or the other format to describe various aspects and features of the invention.

One aspect of the invention includes an apparatus for quickly releasing and replacing a laser in a laser system which includes a first engagement member affixed to a platform having a laser beam delivery system, and a second engagement member attached to a laser source mounted in a compartment of the laser system equipped with a latchable cover.

Further features of this aspect of the invention include the first and second engagement members interfaced for quick attachment and detachment of the laser source in operative relation with the beam delivery system, a deformable spacer abutted against the laser source for further securing the laser source against movement in its operative relation when the cover is fully closed, a switch automatically interrupting power to the laser source whenever the cover is opened, the laser source positioned by the first engagement member with the path of laser beam in alignment with the optical axis of the beam delivery system, and the first engagement member, an optical axis of the beam delivery system, and the second engagement member pre-aligned to a reference.

Another aspect of the invention is a method which includes the process steps corresponding to and performed by the mechanical features described above with respect to the apparatus aspect of the present invention and as set forth in the original method claims hereto. This aspect and these features of the invention are hereby incorporated herein by reference in the interest of brevity.

Still further features of the process aspect of the invention include the process steps of performing an interfacing step without the use of tools, enclosing of the laser source with an attached toollessly latchable cover, performing the enclosing step without the use of tools, and mounting the laser source without the need for any additional beam alignment.

The advantages of the present invention are:

1. Quicker access to the laser source for rapid, routine interchange with another laser source better suited for the particular application or to otherwise exchange a laser source without the need to realign the laser beam to the beam delivery system is optical axis.

2. Tool-less access by non-technical users to accomplish the exchange.

### BRIEF DESCRIPTION OF THE DRAWINGS

FIG. 1 is a perspective view of a portion of a laser material processing platform showing the quick access laser compartment cover of the present invention in a fully closed and latched position.

FIG. 2 is a view similar to FIG. 1 showing the quick access laser compartment cover of the present invention in a partially open position exposing the laser source and engagement members.

### DETAILED DESCRIPTION OF THE INVENTION

### a. The Tool-less Interfacing Method Without Pre-Alignment.

In an earlier commonly assigned application, Ser. No. 09/506,214 filed Feb. 17, 2000, entitled Apparatus And Method For Making Laser Sources and Laser Platforms Interchangeable And Interfaceable hereby incorporated herein by reference, we disclosed a method and apparatus for independently pre-aligning every laser source and every laser material processing platform in a particular manufacturer's line to a predetermined reference whereby any one of the laser sources could be interchanged with any other one of the laser sources in the line, any one of the laser material processing platforms in the line could be interchanged with any other one of the laser material processing platforms in the line, and any one of the laser sources in the line could be interfaced with any one of the laser material processing platforms in the line without any additional alignment requirement during or after the interchange or interface step.

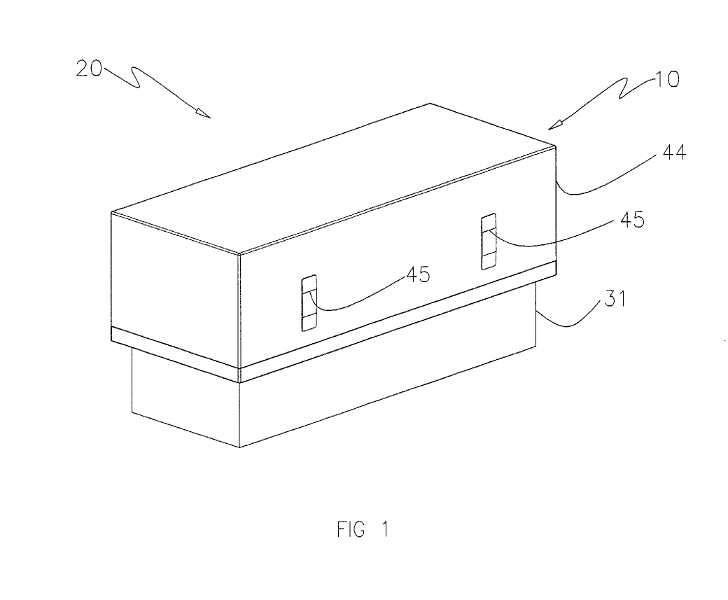

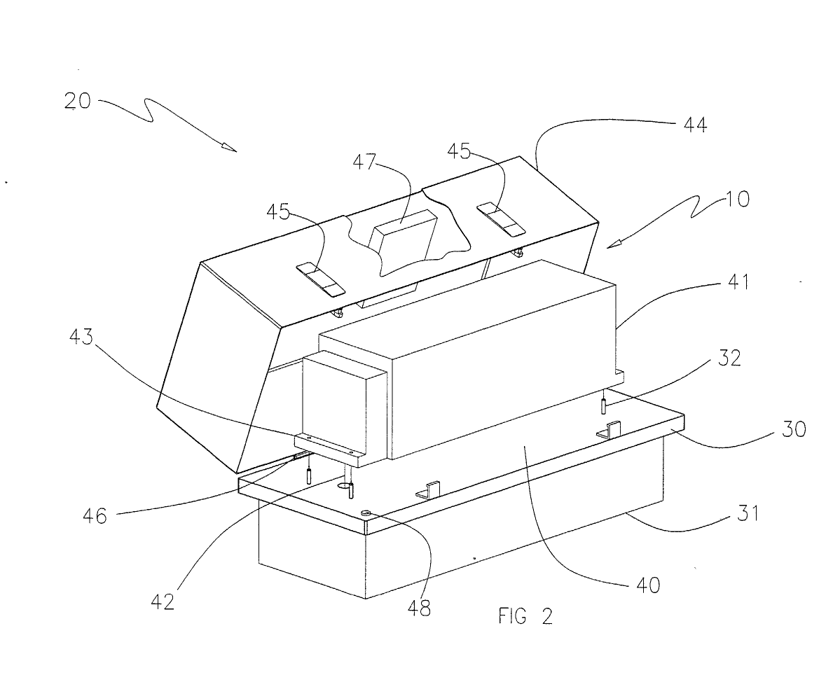

Shown in FIGS. 1-2 is a quick change laser design 10 of the present invention which includes a laser system 20 having a platform 30 in which is mounted a laser beam delivery system 31 supporting a first engaging member 32. Adjacent the platform 30 is a readily accessible, electrical equipment compartment 40 in which is mounted a laser source 41 having a second engaging member 43 which supports the laser source 41 with its laser beam 42 in operative pre-aligned relation with the optical axis (not shown) of the beam delivery system 31. One method of accomplishing the pre-alignment shown in our co-pending application referenced and incorporated herein above.

### b. The Laser System Quick Access Laser Source Compartment Cover.

As seen in FIGS. 1-2 a quick access laser compartment cover 44 is secured to the platform 30 by one or more hinges 46, and, in the fully closed position is secured to the platform 30 by one or more latches 45. The cover 44 is easily opened by pressing latches 45. When the cover 44 is fully closed, a deformable spacer 47 mounted inboard of the cover 44 abuts laser source 41 and snugly holds the engagement members 32, 43 engaged in operative relation.

Power is supplied from a power source (not shown). A switch 48 mounted between the cover 44 and the platform 30 interrupts power whenever the cover is opened.

What has been described in detail above is a tool-less apparatus and method for interchangeably interfacing a laser source with a laser material processing system while simultaneously placing the laser beam of the replacement source coincident with the axis of the beam delivery system without the use of any tools and without the need for additional adjustment. Thus, in accordance with the present invention, these steps become a routine standard operating procedure performable by non-technical users or other personnel.

The foregoing description of a preferred embodiment and best mode of the invention known to applicant at the time of filing the application has been presented for the purposes of illustration and description. It is not intended to be exhaustive or to limit the invention to the precise form disclosed, and obviously many modifications and variations are possible in the light of the above teaching. The embodiment was chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. An apparatus for quickly releasing and replacing a laser in a laser system comprising:
a first engagement member affixed to a platform having a laser beam delivery system, and a second engagement member attached to a laser source mounted in a compartment of the laser system equipped with a latched cover.

2. The apparatus of claim 1 further comprising:
the first and second engagement members interfaced for a attachment and detachment of the laser source in operative relation with the beam delivery system.

3. The apparatus of claim 1 further comprising:
a deformable spacer abutted against the laser source for further securing the laser source against movement in its operative relation when the cover is fully closed.

4. The apparatus of claim 1 further comprising:
a switch automatically interrupting power to the laser source whenever the cover is opened.

5. The apparatus of claim 1 further comprising:
the laser source positioned by the first engagement member with the path of laser beam in alignment with the optical axis of the beam delivery system.

6. The apparatus of claim 1 further comprising:
the first engagement member, an optical axis of the beam delivery system, and the second engagement member pre-aligned to a reference.

7. A method for quickly releasing and replacing a laser from a laser system comprising the steps of:
affixing a first engagement member to a platform having a laser beam delivery system, and affixing a second engagement member to a laser source mounted in a compartment of the laser system equipped with a latchable cover.

8. The method of claim 7 further comprising the step of:
interfacing the first and second engagement members for quick attachment and detachment of the laser source in operative relation with the beam delivery system.

9. The method of claim 8 further comprising the step of:
performing the interfacing step without the use of tools.

10. The method of claim 7 further comprising the step of:
enclosing of the laser source with an attached tool-lessly latchable cover.

11. The method of claim 10 further comprising the step of:
performing the enclosing step without the use of tools.

12. The method of claim 7 further comprising the step of:
abutting a deformable spacer against the laser source for further securing the laser source against movement in its operative relation when the cover is fully closed.

13. The method of claim 7 further comprising the step of:
automatically interrupting power to the laser source whenever the cover is opened.

14. The method of claim 7 further comprising the step of:
positioning the laser source on the laser platform with the path of the laser beam in alignment with the optical axis of the beam delivery system.

15. The method of claim 7 further comprising the step of: mounting the laser source without the need for any additional beam alignment.

16. The method of claim 7 further comprising the step of:
pre-aligning to a reference the first engagement member, and optical axis of the beam delivery system, and the second engagement member.
